(19) United States
(12) Patent Application Publication
(10) Pub. No.: US 2026/0275869 A1
(43) Pub. Date: Sep. 17, 2026

(54) Rotary Vane Internal Combustion Engine

(71) Applicant: Adel Al-Subaih, Kaifan (KW)

(72) Inventor: Adel Al-Subaih, Kaifan (KW)

(21) Appl. No.: 19/079,545

(22) Filed: Mar. 14, 2025

(51) Int. Cl. F02B 55/02; F01C 1/344; F02B 55/08; F02B 55/16

(52) U.S. Cl. CPC F01C 1/44; F01C 11/002; F01C 21/0809; F01C 21/0845; F01C 21/0881; F02B 55/02; F02B 55/08; F02B 55/16

(57) ABSTRACT

This invention relates to a rotary vane internal combustion engine. The engine comprises a cylindrical casing with an inner tangent eccentric rotor. The contact area between the rotor and the inner wall of the casing designed with a slight undercut in the casing wall, corresponding to the rotor radius, to form a tangential contact aria, while allowing the rotor's outer cylindrical surface to rotate tangentially within the casing undercut with a sealing clearance. The rotor has multiple radial or off-radial slots with spring-loaded vane in each, which forms multiple chambers with varying volumes as the rotor rotates within the casing. Each vane fitted with a pivoted sealing shoe at its end, which maintains a sealing contact aria with the inner wall of the casing. The rotating vanes, in conjunction with the fixed rotor/casing tangent contact area, create variable volume chambers that is utilized to generate torque.

### BACKGROUND

The present invention pertains to the field of rotary vane internal combustion engines and, more specifically, to rotary engines characterized by simplified geometries, reduced component count, and enhanced operational reliability.

Rotary internal combustion engines known for several decades, with their origins tracing back to as early as 1834 with the invention of rotary steam engines. Notable advancements include U.S. Pat. No. 1,028,316 to Allyn in 1912, followed by contributions such as U.S. Pat. No. 1,701,534 to Knopp, U.S. Pat. No. 2,988,008 to Wankel—perhaps the most widely recognized rotary engine—and U.S. Pat. No. 5,305,721 to Burtis.

Conducting a patent search using the term “rotary engine” reveals an extensive array of results, often numbering in the hundreds of thousands. To focus the scope of the inquiry, this document prior art emphasizes patents sharing core characteristics of this patent, including cylindrical casings (as opposed to oval or irregular shapes), vane-based mechanisms, single-directional rotational motion (non-reciprocating), and the absence of traditional engine components such as crankshafts, camshafts, or linear pistons.

The related prior art, which is limited to the above, may be subdivided in two main concepts:

The first concept is cylindrical casing with centrally pivoted independent vanes with an eccentric hollow rotor drives the vanes with flexible seal between the rotor vane openings and vanes. Some of the patents that shares this concept are, U.S. Pat. No. 3,886,909 to Balsbaugh in 1975, U.S. Pat. No. 3,782,107 to Bendall in 1974, U.S. Pat. No. 4,508,089 to Baumgratner et al. in 1985, U.S. Pat. No. 3,971,346 to McReynolds in 1976, U.S. Pat. No. 3,902,465 to Stookey in 1975, U.S. Pat. No. 4,848,296 to Lopez in 1989.

In those patents, the eccentric rotor, for each vane, act as a drive (inverted crank slider mechanism type) to generate the variable volume chambers. The rotor body with the vanes and the casing walls and the cover forms a varying volume sealed chambers. The concept is excellent; however, the mechanical orientation and geometry may result in excessive leak issues.

The second concept is cylindrical casing with eccentric rotor with radial or off-radial vanes extended to the cylindrical casing inner wall, forming variable volume chambers. Some of the patents that shares this concept are, U.S. Pat. No. 4,572,121 to Chang in 1986, U.S. Pat. No. 3,964,447 to Normandin in 1976 and many others.

This concept is very popular, simple and logical; however, it has issues with seal when used with high-pressure gases. In most cases, the seal between the vane end and the casing is a weak line contact seal due to the varying angle of contact between the vanes and the casing inner wall.

Other weaknesses issues summarized below:

Weak seal between vane ends and the casing wall, due to the varying angle if contact.

Weak seal between the high-pressure side and the exhaust low-pressure side.

Non-cylindrical casing including oval shaped will have inertia issues when running at high speed. This will result in leak, vibration, and wear.

Some inventions involve complicated mechanisms such as cams, gears, chains, drives, etc.

Many inventions have the air intake cycle (or stroke) as a direct feed for compression and eventually combustion (same as conventional IC engines) which limit the flexibility to optimize the engine operation at all speeds and loads.

This patent adopts the second concept, namely, the cylindrical casing with eccentric rotor, with novel solutions to avoid the above weaknesses issues to achieve effective simple geometry and efficient engine operation. Furthermore, all the chambers seals designed as aria contact seal, not line contact seal. The above achieved with the below key features:

Cylindrical casing: cylindrical casing adopted to avoid high-speed inertia issues with the vanes movements against the casing wall. Cylindrical casing also important to achieve good seal using pivoted shoe profiled to the casing wall radius. In addition, cylindrical casing with eccentric rotor is a simple geometry that generate variable volume chambers without a drive.

Casing undercut: a short undercut made in the cylindrical casing inner wall to the radius of the eccentric rotor to form tangential contact aria to seal between the casing and the eccentric rotor while the rotor is free to rotate within it. The casing undercut made long enough to seal, while short so that the shoe can hover over it without interruption. This will introduce an effective dynamic seal between the high-pressure side (power side) and the low-pressure side (exhaust side), which is extremely useful in the engine operation.

Pivoted shoe: because of the varying angle between the vanes and casing, a pivoted shoe introduced to seal between the end of the vanes and the casing inner wall. The shoe bottom profiled to the casing inner wall radius to form an aria of contact seal with the casing. The pivot made with tight sealing clearance using high accuracy machining. This will result in good seal with less wear.

Long shoe: to avoid disruption of the rotation as the shoe passes over the undercut, the shoe made long enough to hover over the short casing undercut without disruption. This will further require that the rotor has undercut in its outer surface to fully house the shoe inside it as the shoe hover over the casing undercut. The rotor/casing undercut seal and the shoe/casing seal alternate sealing function with overlap to maintain good, continuous, and reliable seal throughout the pass over process.

Compressor and air tank: cylindrical casing with eccentric rotor and vanes, for a full rotation of the rotor, each chamber will be born from virtually zero volume (intake), expand to maximum volume (power), then shrink gradually to virtually zero volume (exhaust). Hence, the engine cycles will not have room for compression cycle, which carried out by an external compressor (driven by the engine) with an air storage tank. This feature will supply compressed air for the intake cycle during operation, allow for adjustable expansion ratio. Pressurized air also used to kick-start the engine without the need of starter motor.

From the above, the variable chambers sealed all around with aria contact seal, which will provide effective seal with less friction and wear. The casing is cylindrical except for the casing slight undercut which will not affect the operation as the shoe will smoothly hover over it without interruption. From the second and forth key features, namely, casing undercut and long shoe, the sealing between the high and low pressure sides is made consecutively (with overlap) by the rotor rotating within the casing wall undercut and with the long shoe smoothly hovering over the entire casing undercut, in contact with the casing inner wall all the time. With the features of variable volume chambers with effective seal and less friction and wear, the internal combustion cycle applied to generate work.

### SUMMARY OF INVENTION

Therefore, the present invention provides a rotary vane internal combustion engine.

An aspect of the invention comprises an engine block integrating a cylindrical power casing, an eccentric tangential rotor with radial or off-radial vanes, and a compressor.

The power casing also comprise of a fuel injector, an air inlet with one-way valve, an exhaust outlet, and a spark plug.

### BRIEF DESCRIPTION OF THE DRAWINGS

FIG. 1: Prospective view of the engine, front and back, showing all external components.

FIG. 2: Assembly view of the engine block showing all the inner parts.

FIG. 3. Engine block inside view, showing the casing undercut, intake port, exhaust ports, fuel injection, spark plug, and air/gas flow slots.

FIG. 4: Vane and shoe, (a) prospective view and (b) assembly view.

FIG. 5: exaggerated schematic progressive view showing the shoe hover over the casing undercut without leak or interruption.

FIG. 6: Successive operation view for three-vane engine.

FIG. 7: Successive operation view for two-vane engine.

FIG. 8: Successive operation view for single-vane engine.

FIG. 9: Prospective view of two power blocks engine, front and back, showing all external components.

### DETAILED DESCRIPTION

The following detailed description of exemplary embodiments of the invention, reference made to the accompanying drawings that form a part hereof, and in which shown by way of illustration specific exemplary embodiments in which the invention practiced. These embodiments described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

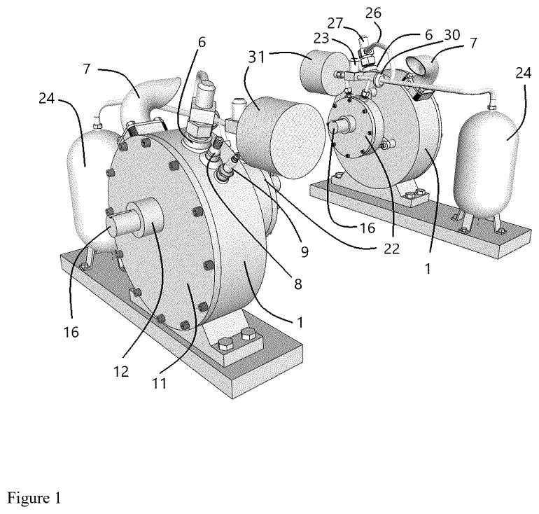

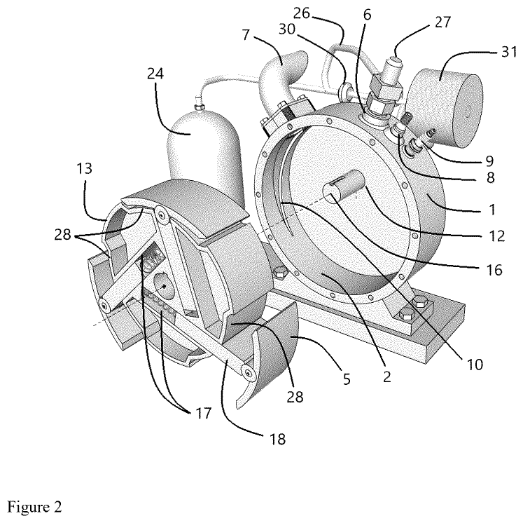

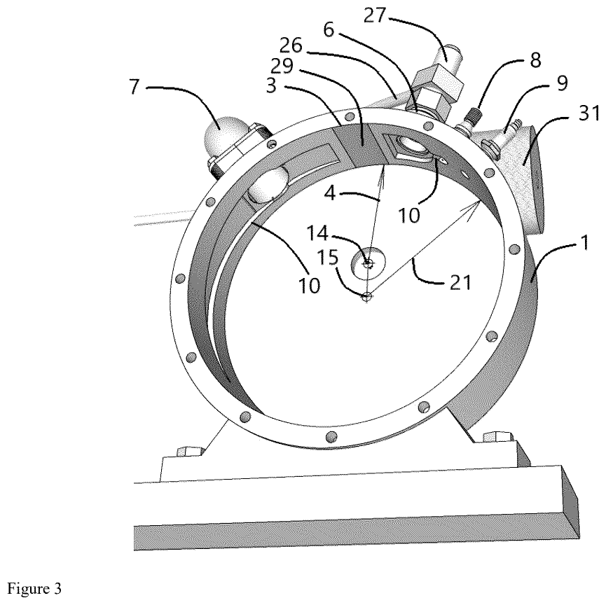

FIG. 1 shows all the external engine parts; FIG. 2 shows all the internal parts and FIG. 3 shows the casing inner details. With reference to those figures, the main components are:

Power block: power block 1 has a cylindrical inner wall casing 2, while the outside wall can be fined for air-cooling or designed with double wall for water-cooling. The cylindrical inner wall has an undercut 3 made to the rotor radius 4 with minimum sealing clearance. The undercut 3 located between the intake port 6 and exhaust port 7 and made long enough to seal with the rotor 13 outer surface. The power block 1 also has intake port 6, exhaust port 7, fuel injection port 8 and spark plug port 9. The inner wall casing 2 have slots 10 to allow air and gases to bypass the shoes 5. The locations of slots 10 designed as the operation requires. The power block 1 also has a cover 11 with eccentric output shaft 16 through openings 12, which is all the way through the block and the cover.

Rotor: a rotor 13 mounted eccentrically 14 to the casing center 15 fixed to the power output shaft 16, while its outer surface rotates tangentially within the casing undercut 3, as described above. In the preferred embodiment, the rotor 13 has three radial or off-radial slots 17 with spring-loaded vanes 18 to freely slide within it. The rotor 13 outer surface cut 28 to house the shoe 5 within it, while the shoe 5 hover over the casing undercut 3 without interruption or leak.

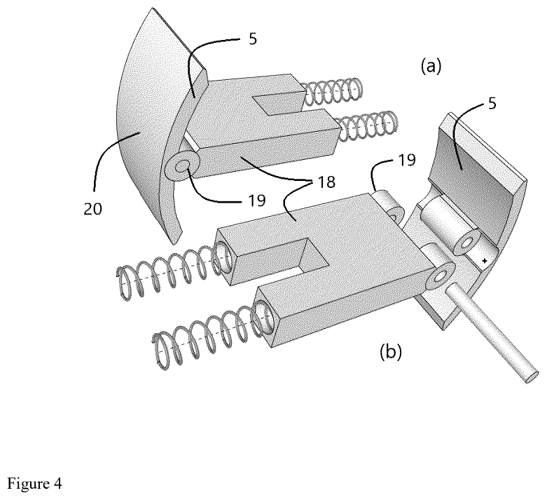

Vanes and shoes: three spring-loaded vanes 18 mounted within the rotor slots 17 with sealing shoes 5 hinged 19 at their ends, FIG. 4. The hinges 19 are precision machined to allow for free limited needed rotation without leak. The shoe 5 outer surface 20 cut to the casing inner wall radius 21 to form a sealing contact aria with the inner casing wall 2. The shoe 5 made long enough to hover over the casing undercut 3 without interruption or leak. In other words, it is always in contact with the cylindrical casing 2 inner wall.

Power shaft: the power shaft 16 fixed to the rotor 13 and eccentrically extended out though the power block 1 back wall and the casing front cover 11 through the shaft openings 12. The power shaft drives a compressor 22, either directly, as shown, or through some mean of power transmission. The power shaft 16 also drive any other auxiliary equipment, controls and deliver output work.

Compressor: the engine equipped with a compressor 22 of any type designed to deliver the required quantities of air at the required pressure. The compressor equipped with bypass valve 23 to idle the compressor load when starting the engine and to avoid over-pressure in the air tank 24. It also equipped with one-way valve 30 to the tank 24 and an air filter 31. The compressor inner details not described here nor claimed.

Air tank: the engine is equipped with air tank 24 to store sufficient amount of pressurized air for starting and operation.

Air intake port: the air intake port 6 is to feed pressurized air to the power chamber in preparation for combustion, power state. The port 6 equipped with one-way valve 25 to avoid combustion pressurized gases back flow during power state. The air supply feed line 26 equipped with adjustable pressure regulator 27, electrical or mechanical, to adjust air pressure as the optimum operation requires.

Casing undercut 3 sealing feature: this is one of the most important feature of this engine as it seals between the high-pressure side 6 (power side) and the low-pressure side 7 (exhaust side), while allowing the shoe 5 to hover over the casing undercut 3 without interruption to motion nor to the seal. This achieved by making the undercut 3 long enough to seal and the shoe 5 long enough to hover over it without interruption. It will be called here “tangent aria seal 29”.

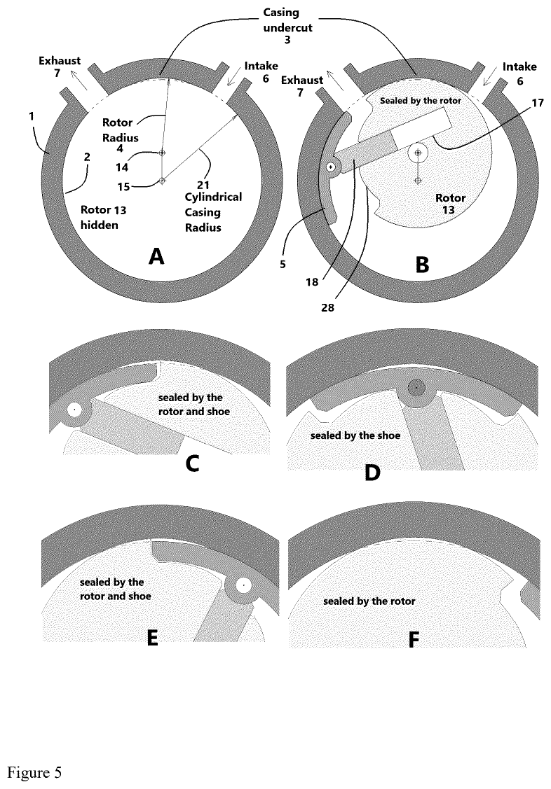

FIG. 5A shows the casing undercut with the rotor hidden; FIG. 5B shows the rotor within the undercut making a good seal with the casing while rotation. FIG. 5 (B, C, D, E, F) shows successive views of the shoe as it hovers over the casing undercut. At B and F, the tangent seal fully sealed by the rotor within the undercut, while at D the tangent seal is fully sealed, with the casing, by the shoe sealing both sides of the undercut. At C and E, the tangent seal is fully sealed by both the rotor/casing undercut and the shoe/casing overlapped in sealing the tangent aria seal 29.

Casing inner slots: the casing inner wall 2 has slots 10 for intake 6 and exhaust 7 to bypass the shoe 5 blockage at certain locations. The extent of the slots 10 carefully defined as the design require for exhaust and intake start and end locations. The slot also made with gradual width and depth for relaxed release of pressurized gases to avoid the need of bulky mufflers.

Power block 1, containing the eccentric rotor 13 along with vanes 18, shoes 5, and power block cover 11, creates sealed chambers that change in volume as the rotor 13 rotates. When fuel injection 8 and spark 9 timed correctly, this setup will facilitate continuous internal combustion engine operation.

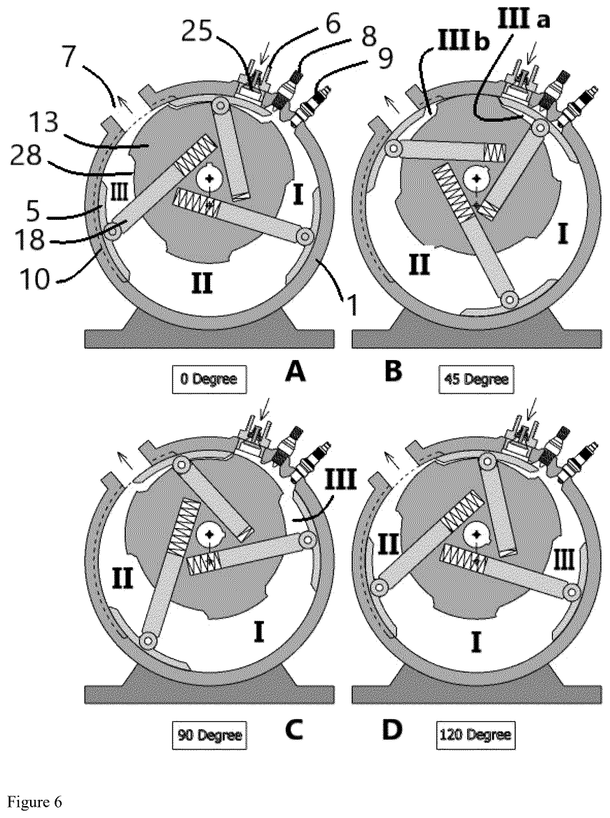

The operation:
The term “stroke” is not technically applicable in this context; hence, the term “state” used to describe the condition of the chamber during operation. The operation for three-vane engine described below with reference to FIG. 6:
FIG. 6A: in this position, chamber I is in power state. Chamber II is at the end of the previous power state, at its maximum volume, about to exhaust through the slot 10 to the exhaust port 7. Chamber III is in exhaust state.
FIG. 6B: in this position, chamber I is still in power state and expanding. Chamber II is in exhaust state. Chamber III divided into two chambers by the “tangent aria seal 29”. The left side IIIb is in the remaining exhaust state, while the right side IIIa is about to intake fresh pressurized air, intake state.
FIG. 6C: in this position, chamber I is still in power state and further expanding. Chamber II is in exhaust state and further exhausting. Chamber III is in intake state and ready for fuel injection and spark at any instant. At any instant, chamber III will become in power state and will take over the previous power state in chamber I, with partial overlap.
FIG. 6D: in this position, chamber III is in full power state. Chamber I is in the maximum volume, and about to exhaust. Chamber II is in exhaust state.

The operation can be visualized as a basic air-driven motor, where, additionally, combustion introduced in the chambers at entry point to generate extra pressurized combustion gases, resulting in increased work output.

The above covers 120 degrees of rotor rotation and the chambers will take over successively, with partial overlap, for continuous rotational motion.

It worth to mention here that the start of the power state can be timed live during operation, little earlier or little later result in higher or lower expansion ratio. This feature is useful to optimize operation depending on the engine speed and load condition.

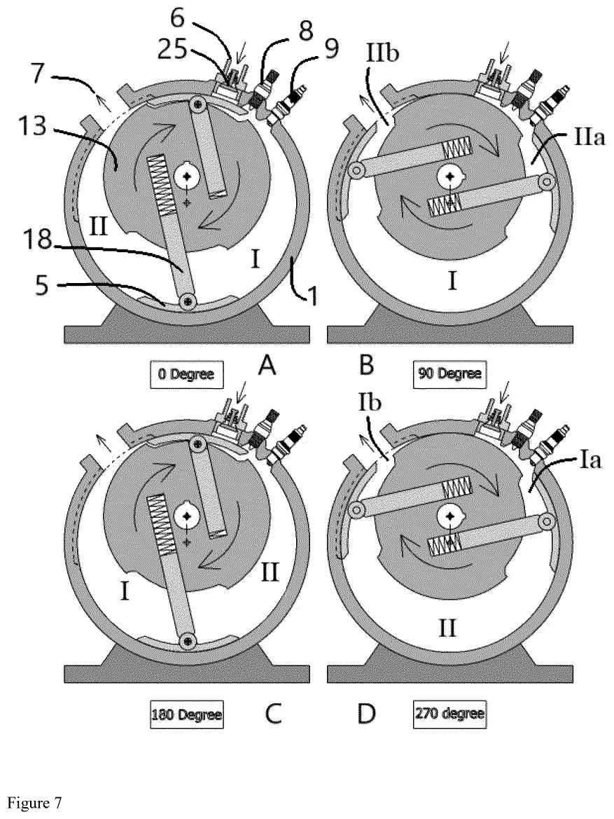

In another embodiment, the engine designed with two vanes, FIG. 7. It will work similar to the three-vane engine, however, featuring a larger expansion ratio. The two-vane engine is balanced and generate work, with slight overlap in power states chambers, as explained below:
FIG. 7A: in this position, chamber I is in power state. Chamber II is in exhaust state through the exhaust port 7.
FIG. 7B: in this position, chamber I is at the end of the power state, at the maximum volume and about to exhaust through the slot 10 to the exhaust port 7. Chamber II now divided by the “tangent aria seal 29” into two chambers. The left side, chamber Ilb, is in the remaining exhaust state, while the right side, chamber lla, is in intake state charging the chamber with fresh pressurized air in preparation for combustion. At the instant combustion take place, the chamber lla will become in power state and will take over in driving the engine.
FIGS. 7C and 7D is a repetition of 7A and 7B but for chamber II as a power state and chamber I in exhaust state.

The engine is simple, well balanced, few parts and compact.

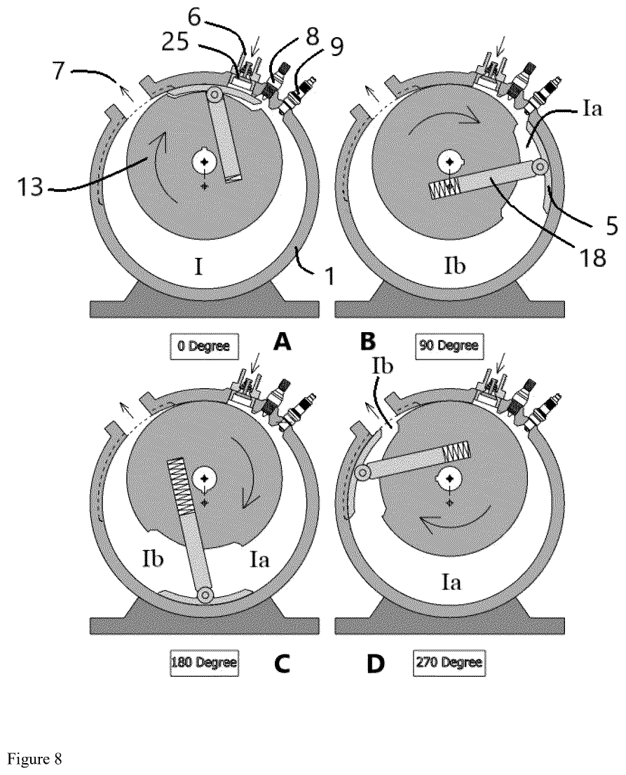

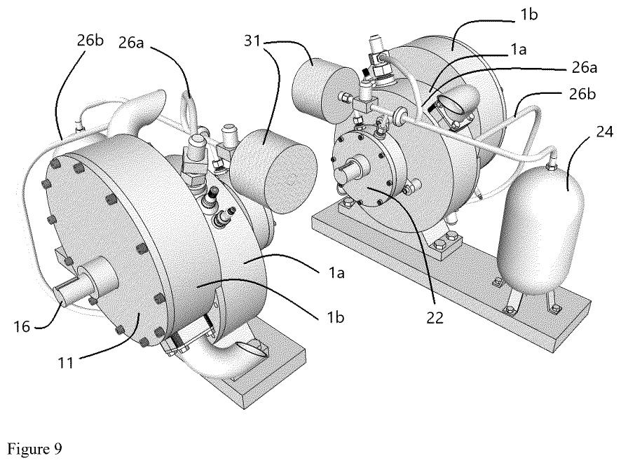

In a third embodiment, the engine designed with a single vane (see FIG. 8). This configuration will also function like the three-vane engine but will achieve an even larger expansion ratio. However, it will require either a balancing mechanism on the opposite side of the rotor, complemented by a flywheel (not shown), or alternatively, the engine can built with dual power blocks 1a and 1b, (see FIG. 9), oriented 180 degrees out of phase for balancing and successive continuous operation. The operation summarized as the following:
FIG. 8A: in this position, chamber I is in exhaust state through the exhaust port 7.
FIG. 8B: in this position, Chamber I divided by the “tangent aria seal 29” into two chambers. The left side, chamber Ib, is in the remaining exhaust state, while the right side, chamber la, is in intake state charging the chamber with fresh pressurized air. At some instant combustion takes place making the chamber in power state.
FIG. 7C: in this position, chamber la is in power state while chamber Ib is in exhaust state.
FIG. 7D: in this position, chamber la is in its final power state and about to exhaust while chamber Ib is in exhaust state.

In this embodiment, the engine requires balancing mechanism and flywheel (not shown) to complete the rotation to the next power state. Alternatively, the engine can be made with two or more engine blocks 1a, 1b, FIG. 9, mounted out of phase on the same output shaft 16 to balance the rotating parts of the engine, for smoother operation and higher power.

In any of the aforementioned embodiments, the engine can be designed with multiple power blocks 1a, 1b positioned at appropriate angle with each other, on the same output shaft 16.

Proper operation of the engine necessitates lubrication, which can be incorporated into the fuel or provided by a dedicated oiling system of any type that reaches the necessary lubrication points. This system is not described here nor claimed.

In conventional piston engines, the term “stroke” specifically refers to the movement of the piston between the Top Dead Center (TDC) and Bottom Dead Center (BDC). For example, in a four-stroke engine, the operational sequence includes intake, compression, power, and exhaust strokes. While this terminology is not directly applicable to the present invention, certain aspects of the processes are conceptually similar. In the present design, the operational processes consist of the intake of pressurized air, power generation, and exhaust. Notably, the compression “stroke” is eliminated within the power block, as air compressed externally by a compressor driven by the engine itself. Therefore, this engine can be conceptualized as a three-stroke (or three-cycle) engine.

In this engine design, there are no explicitly defined Top Dead Center (TDC) or Bottom Dead Center (BDC) positions. Instead, the combustion chambers initially configured with virtually zero volume, which increases because of the rotation produced during the preceding power state, the contribution of rotational inertia, and the pressurized air introduced via the intake port. The volume of the chamber continues to expand until it reaches the optimal power volume, at this point fuel injected and an ignition spark introduced to ignite the air-fuel mixture, thereby initiating the power state. The one-way valve 25 in the intake port 6 will block gases from back flow. Following ignition, the combustion gases expand to the maximum chamber volume, constrained by two successive vanes. This condition corresponds to the BDC, at which stage the release of combustion gases commences through the designated slot on the casing to the exhaust port.

The illustrations of embodiments described herein intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

1. A rotary vane internal combustion engine, comprising:
an engine block, wherein the engine block integrates a cylindrical power casing, an eccentric tangential rotor with radial or off-radial vanes, and an external compressor; wherein the cylindrical power casing further comprises an air inlet with one-way valve, a fuel injector, a spark plug, and an exhaust outlet: and wherein the cylindrical power casing has an undercut formed in the inner wall thereof corresponding to the radius of the eccentric tangential rotor, the undercut providing a tangent area seal between the high-pressure side and the low-pressure side of the engine block, and the external compressor is configured to deliver compressed air to a separate air tank that supplies the air inlet of the cylindrical power casing with already compressed air such that compression of working fluid is performed externally of the cylindrical power casing.

2. The
rotary vane internal combustion engine of claim 1, wherein the cylindrical power casing has the eccentric tangential rotor with multiple radial or off-radial, spring-loaded, vanes, forming multiple variable-volume chambers.

3. The rotary vane internal combustion engine of claim 1,
wherein the cylindrical power casing is in cylindrical shape with the undercut made to the eccentric tangential rotor with sealing clearance, the undercut having a length sufficient to seal between the eccentric tangential rotor and the cylindrical power casing while being short enough that a sealing shoe at the end of each vane hovers over the undercut without interruption.

4. The rotary vane internal combustion engine of claim 1,
wherein the cylindrical power casing is equipped with ports for the air inlet with one-way valve, the fuel injector, the spark plug, and the exhaust outlet port.

5. The rotary vane internal combustion engine of claim 2,
wherein the vanes have at their ends sealed hinged shoes with profiled outer surface cut to the cylindrical power casing inner radius to form sealed area contact with the cylindrical power casing inner wall; the shoes being made long enough to hover over the cylindrical power casing undercut without interruption.

6. The rotary vane internal combustion engine of claim 2,
wherein the eccentric tangential rotor has a cut in its outer surface to house the shoe as it passes over the cylindrical power casing undercut.

7. The rotary vane internal combustion engine of claim 3,
wherein the tangential undercut is sealed alternately, with overlap, by the cylindrical outer surface of the eccentric tangential rotor with the undercut in the cylindrical power casing and by the long shoe hovering over the cylindrical power casing undercut without interruption.

8. The rotary vane internal combustion engine of claim 1,
further comprising recess slots on the inner casing wall extended from the intake and exhaust ports to extend intake and provide gradual release of combustion gases to avoid the need of a bulky muffler, the exhaust recess slot having a gradually increasing width and depth to the exhaust port for relaxed release of combustion gases.

9. The rotary vane internal combustion engine of claim 1,
wherein the engine comprises multiple cylindrical power casings, offset mounted on the same output shaft.

10. The rotary vane internal combustion engine of claim 1,
wherein the engine is configured such that the pressurized air from the air tank crank-starts the engine through the air inlet with one-way valve and into a working chamber formed in the cylindrical power casing, avoiding the need of a starter motor.

11. The rotary vane internal combustion engine of claim 1,
further comprising auxiliary equipment including one or more of a remote air tank, fuel pump, pressure regulators, valves, and controllers.

12. (canceled)
